(19) United States
(12) Patent Application Publication
(10) Pub. No.: US 2004/0217615 A1
(43) Pub. Date: Nov. 4, 2004

(54) Multifuntion box for detachable mounting in a vehicle passenger compartment

(75) Inventors: Martin Lindstrom, Gothenburg (SE); Volker Stein, Wiesbaden (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignees: Adam Opel AG; Lear Corporation GmbH & Co. KG

(21) Appl. No.: 10/738,610

(22) Filed: Dec. 17, 2003

(30) Foreign Application Priority Data
Dec. 19, 2002 (DE) 102 60 502.5

(51) Int. Cl. B60R 7/00

(52) U.S. Cl. 296/24.34; 224/275

(57) ABSTRACT

A multifunction box (1) for mounting between the two outer rear seats of a car, includes a first container part closable by a lid that can be swivelled away, the lid of said container part forming an arm support in the closed state, and a second container part at the front in the direction of travel for the accommodation of various functional parts. The multifunction box (1) includes a bottom section having a latching mechanism, by which the multifunction box (1) can be connected in a quickly releasable manner to a vehicle mounted console (2).

### DESCRIPTION

The invention relates to a multifunction box for detachable mounting on a specific support in the passenger compartment of a vehicle, in particular between the two outer rear seats of a car, consisting of a first container part, closable by a lid which can be swivelled away, the said lid in the closed state forming an arm support, and a second container part at the front in the direction of travel for accommodating various functional parts.

These types of functional boxes are known in numerous shapes and versions and they are installed at the factory or as an accessory part mainly as the central console between the front seats of motor vehicles and they provide accommodation and shelf storage for various utensils. Often these boxes are also used as central armrests with the lid being upholstered as an arm support.

A known multifunction box of the type described and available on the market is intended for installation as an add-on part on the middle seat position of the rear seat bench of a car. Its basic construction is approximately L-shaped, whereby one leg of the L can be set down on the central tunnel of the vehicle in front of the rear seat bench and the other leg of the L is formed as a storage compartment and as central armrest and is supported on the middle position of the rear seat bench. The attachment of the known multifunction box occurs on one hand by placement on the central tunnel of the vehicle and on the other hand by the insertion of two guide lugs in the gap to the side of the central armrest already present on the vehicle. In addition, the multifunction box is constrained with the lap belt of the middle rear seat position. To achieve this, the lap belt is pulled through belt guides on the seat side of the multifunction box, then latched into the belt buckle for the lap belt and tightened. The known multifunction box is adapted in its shape to the geometrical conditions in the specific vehicle model.

A fold-down multifunction box built into the rear seat bench of a vehicle is known from JP 57-80935.

With the multifunction console folded down, the controls of an air conditioning system and a radio-cassette unit are accessible in the console. The multifunction box is intended for quick removal.

It has already been suggested that the long-cargo space between the boot and the rear seat of a vehicle is used as storage space for the installation of a cooler box (DE 41 02 646 C2). Other functions in conjunction with the cooler box, e.g. for expansion to a multifunction box are not really possible with this solution, because the cooler box is positioned essentially inaccessible in the long-cargo space.

Finally, in DE 198 08 381 A1 a multifunction box is described which can be adapted to different, individual types and models of vehicle and which comprises a module system with various mounting parts and functional parts. The multifunction box can be fitted with the most varied functional elements to match the individual user's requirements. With the functional and mounting parts of the module system, adaptation to both individual user requirements and to specific installation and power connection conditions of a specific vehicle can occur with defined energy interfaces, information interfaces and mounting interfaces. The multifunction box can include a number of shelf and accommodation compartments depending on requirements.

For the adaptation of the support surface of the known multifunction box to the seat contour, a seat support, specific to the vehicle, is provided, the bottom surface of which is formed correspondingly in each case to an individual vehicle seat contour, whereby the surface of the seat support forms in each case the contact surface for the multifunction box. According to this state of the art, the seat support should consist of elastic material, for example a foam material.

For mounting the known multifunction box a gripper-shaped support foot is provided at the front, which spans the central tunnel with a clamping action and an insertion extension at the back which is designed to suit the vehicle and which can be inserted in a gap between the seat bolster and a bordering backrest of a back seat bench. In addition the multifunction box is attached with the middle lap belt on the back seat bench. To achieve this, a box belt buckle part and a box tongue are fitted to the box. The box tongue is inserted into the belt buckle of the middle lap belt for fixing the multifunction box and the buckle tongue of the middle lap belt is latched into the box belt buckle part. After tightening the middle lap belt the multifunction console should be held firmly even under high stresses such as can occur with vehicle collisions. Apart from shelf and accommodation compartments, container holders and a cooler box are fitted to the front of the known multifunction box.

The object of this invention is to provide a detachable multifunction box which can be fixed in the vehicle, which can be manufactured with low costs, which can be quickly and easily installed and removed and which offers the user a large range of functions in the tightest space. The attachment of the multifunction box should also be able to withstand high stresses such as can occur during vehicle collisions.

For the solution of the object of the invention a multifunction box is suggested which exhibits in its bottom section a latching mechanism, with the aid of which the multifunction box can be joined to and quickly removed from a console, designed specifically for a vehicle and which can be joined to the vehicle and which forms the support for the multifunction box.

The multifunction box designed according to the invention can be firmly latched to the vehicle by means of the console and can however be easily removed after releasing the latch. Consequently, the multifunction box can be installed user-specifically in the vehicle or, if the space is to be used for other reasons, it can be removed as required. The console on which the multifunction box is supported and is latched is designed and adapted appropriate to the latching mechanism. It is adapted to the relevant vehicle and the same multifunction box can though be used in various vehicles if the console and its attachment is designed appropriately specifically to the vehicle. The invention enables, without extensive conversion work as is required in the state of the art according to DE 198 08 381 A1 for example, a multifunction box to be installed quickly and securely in the vehicle with functional elements arranged in the tightest space.

Preferably the latching/unlatching actuator for the latching mechanism holding the multifunction box on the console is provided in one of the side walls of the front container part. The latching mechanism is released by manual delatching, for example by throwing a spring-actuated lever, so that the multifunction box can be lifted off from the console. Latching occurs automatically when the multifunction box is placed on the console, e.g. by a pushing movement of the multifunction box in a guide with the spring-loaded latches or a similar component latching and locking the multifunction box on the console. To prevent the multifunction box from being released from the console unintentionally or without authorisation, e.g. by children, the latching/unlatching actuator is protected against unauthorised use. This can be achieved for example by a lock with which the lever for unlatching can be locked.

To check that the multifunction box is properly latched to the console, a latching-status viewing window is fitted in one side of the multifunction box, preferably in its front container part, with the latching status being indicated for example by a change in colour (red/green).

In order to enable the use of electrical and electronic functions of the multifunction box and, despite this, to simplify the handling of the multifunction box when fitting it into and removing it from the vehicle, according to another feature of the invention a contact plug is formed in a section of the multifunction box which is not visible, the said plug being able to be connected to an electrical connection interface integrated into the console when the multifunction box is placed on the console.

According to a particularly favourable feature of the invention, an accommodation compartment formed within the first container part and open at the top, bounded on both sides by inner walls running in the longitudinal direction of the vehicle and essentially parallel to the outer walls, between which and the inner walls a slot-shaped intervening space is formed in each case, in which a table board, which can in each case be fixed to the container part, can be lowered into a rest position. In the extraordinarily compact multifunction box the boards of two tables are accommodated which can be brought out as required and can be swivelled into a position which is comfortable for the user. When the tables are not used, they can be lowered within the multifunction box in the accommodation compartments formed at the side in a manner similar as is known from armrests in aircraft seats.

According to the invention the table boards can, for use as a table, be swivelled about two mutually perpendicular horizontal swivel axes from their vertically orientated rest position to their essentially horizontal table position. Various fixing methods and swivel fittings are conceivable. The arrangement of the table boards in the rest position within the multifunction box is especially space-saving, so that, according to another feature of the invention, it is possible to form the accommodation compartment of the first container part as an active cooling compartment.

According to another feature of the invention, it has proven favourable if the cooling compartment, which is open at the top, is tightly closed by the bottom of an essentially flat shelf-storage compartment, which, independently of or together with the lid for the first container part, can be swung open. With the aid of an appropriate closing system the user of the multifunction box can either open the shelf-storage compartment to gain access to the utensils stored there or, by actuating another closure device, the user can open the shelf-storage compartment together with the lid to gain access to the cooling compartment. In this case the lid closes the shelf-storage compartment so tightly that none of the utensils contained in it can fall out.

According to a favourable development of the multifunction box, controls for audio and or video functions and/or for the control of the on-board electronics are arranged in the front container part. The controls are ergonomically favourable arranged such that they are easily reached by the hand of the operator whose arm rests on the arm support. Using the controls, the stereo or video system or the air conditioning system can be regulated, for example.

It is also favourable if, according to an embodiment of the invention, the controls are at least partly covered by an essentially horizontal cover plate arranged as an extension of the armrest. The cover plate protects the controls and covers the section of the front container which is not always to be accessible. For the controls which are always to be accessible to the user, the cover plate exhibits at least one punch-through for operating these controls. Then, according to the invention, the front of an audio appliance can, for example, be left free in the cover plate.

According to the invention, for further functions of the multifunction box, provision is made such that the cover plate for fully releasing the controls and/or other functional parts arranged in the front container part can be removed from its covering position. Consequently, those controls can be covered, the functions of which are not continually needed, but access is possible without problem when the cover plate is removed.

Also in a favourable development, the closed cover plate can cover an accommodation compartment for small utensils as well as the controls.

It is especially favourable if, when the cover plate is opened, it can be moved upwards guided on guide strips and locked in various height positions. Here, telescopic rods or strips lift the cover plate approximately vertically upwards and present the previously covered space free for the user. In particular, if according to a special feature of the invention, the cover plate is formed as a support console, adjustable in height, with a holder for a DVD player or another electronic appliance, the stepless height adjustment of the cover plate then proves useful in that the appliance can be positioned at a comfortable height for the user.

Preferably in the region underneath the cover plate and in the front container part, drinks can-holders and/or accommodation compartments can be brought out or swivelled out, as is already known. It is particularly useful if, according to a further development of the invention, a refuse container is provided in the lower section of the front container part, which, for example, is accessible by swivelling out a cover flap or by pulling out a drawer.

Furthermore, it has been proven worthwhile if at least one on-board power socket is provided in the front container part and is accessible externally. Any load can be connected to this sort of socket, such as for example adapters of game appliances, mobile CD players or cassette appliances. Also, reading lamps, etc. can be connected.

The sockets receive power by means of cables permanently wired in the multifunction box which are connected once the multifunction box is connected to the integrated interface of the electrical connection by being placed on the console.

Since the electrical and electronic appliances and elements integrated into the multifunction box require air to be supplied and extracted, it is provided in a further feature of the invention, that, in the lower section of the first container part, an air supply duct runs extending in the longitudinal direction of the vehicle, through which fresh and cooling air is fed from the air supply duct opening near the seat backrest to the front part of the multifunction box.

To support the air supply a fan can be favourably fitted in the region of the air supply duct opening.

The multifunction box exhibits a latching mechanism for detachable and latchable connection to a console. This mechanism is formed such that easy fitting and removal of the multifunction box on the console is ensured. To achieve this it is advantageous if the latching mechanism exhibits at least one latching unit formed similar to a hook, pointing in the direction of the vehicle floor for engaging a corresponding recess of a console. Here, the latching unit engages behind a corresponding region of the console. Fitting occurs in an advantageous manner by placing the multifunction box essentially vertically on the console so that the latching unit can interact with a corresponding region of the console. To secure the multifunction box against coming loose, the multifunction box is moved essentially horizontally backwards towards the rear of the vehicle after the vertical placement. In this way a connection between the multifunction box and the console is realised which is secure in a crash.

In order to realise a suitable high-strength mechanical connection which also functions reliably in an accident, collision or crash, it is advantageous if the latching mechanism exhibits four latching units, whereby one latching unit is arranged in each corner region of the essentially rectangular bottom which essentially faces the vehicle floor. In this manner the forces occurring in a crash can be optimally deviated so that the multifunction box is securely mounted on the console.

For the secure connection of the multifunction box with the console a measure improving the invention provides for the hook-type latching mechanism to exhibit a horizontal part and a vertical part, whereby the horizontal part is connected by means of the vertical part to the bottom of the multifunction box so that between the horizontal part and the bottom of the multifunction box a space similar to a groove is formed, in which an appropriate protrusion of the console can be accepted, so that a connection between the console and the multifunction box can be realised which is secure in a crash. Due to the protrusion, a high-strength connection between the multifunction box and the console can be realised in a small installation space, whereby the connection does not protrude beyond the multifunction box/console unit and so no snagging producing an unintentional release of the multifunction box from the console can arise.

The connection unit secures the multifunction box essentially against a vertical movement. To prevent an essentially horizontal movement, it is advantageous if the latching mechanism exhibits a catch unit which is connected to the latching/delatching actuator, whereby the catch unit prevents an undesired release of the multifunction box from the console. In this way an additional retainer is realised which can only be operated by means of a latching/delatching actuation.

An embodiment of the invention is illustrated in the drawing and is described in the following. The following are shown:

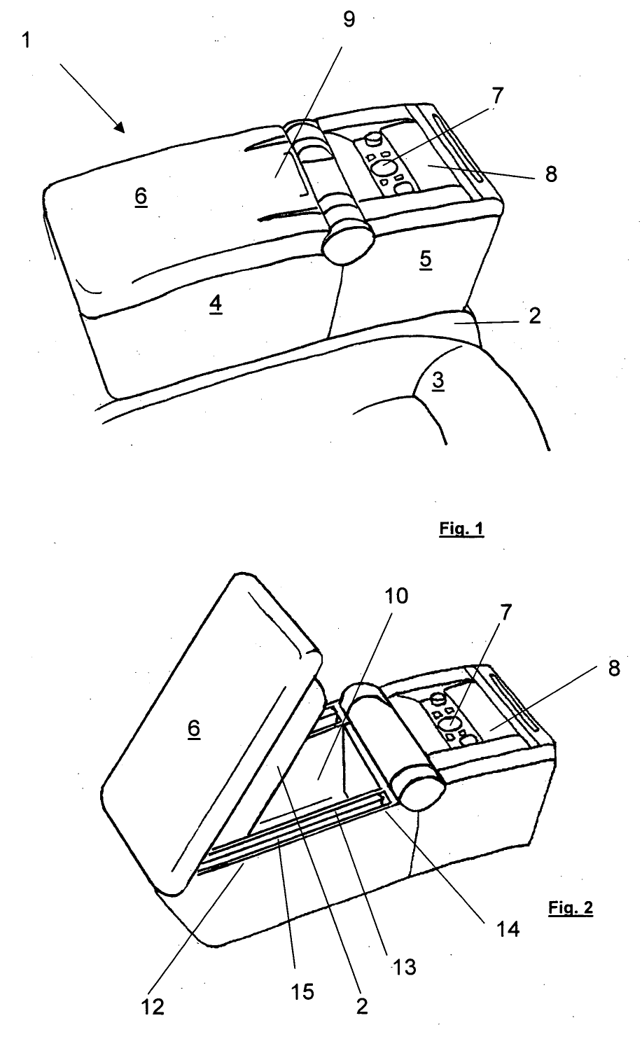

FIG. 1 the multifunction box according to the invention with the console in the closed installed state,

FIG. 2 the multifunction box according to FIG. 1 with opened lid,

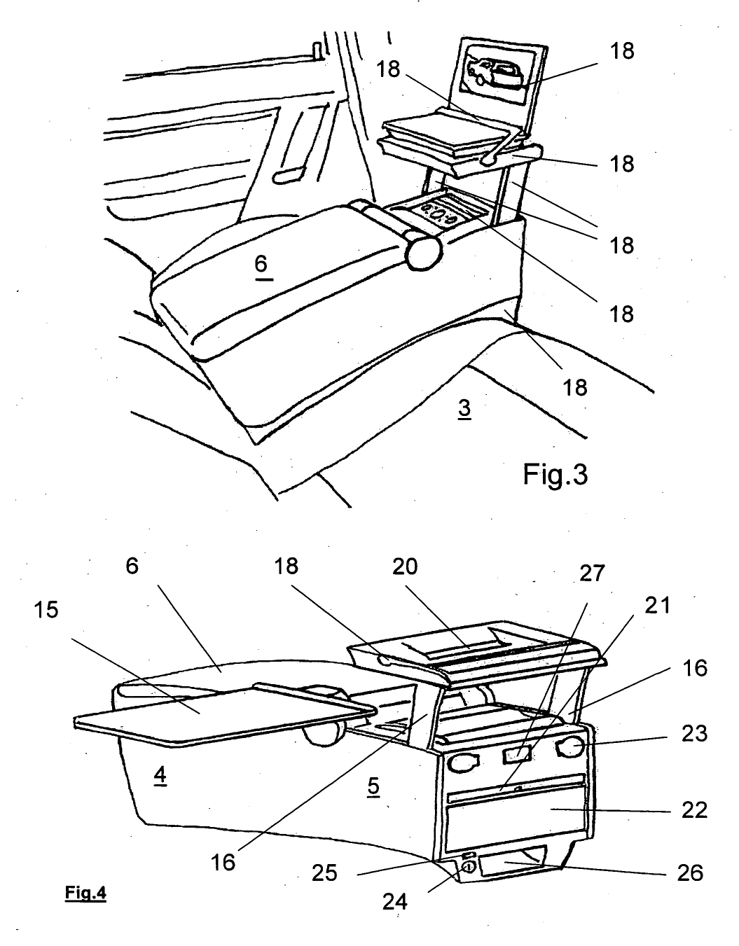

FIG. 3 the multifunction box according to the invention with extended cover plate and DVD player, and

FIG. 4 the multifunction box according to FIG. 3 with swivelled out table and extended cover plate.

In the drawing in FIG. 1 the multifunction box according to the invention, which overall is designated with 1, is illustrated in schematic form. The multifunction box 1 is attached for quick release on the console 2, which acts as a support, using a latching mechanism (cannot be recognised in the drawing); the console itself is firmly joined to the vehicle and in fact, as can be seen in the embodiment, between the two outer rear seats of a car. In FIG. 1, as indicated with 3, the right-hand rear seat in the driving direction is partly illustrated.

The latching mechanism (not shown) exhibits four L-shaped latching units which are formed like a hook. The latching units are here arranged in the corner regions of the bottom of the multifunction box 1 so that with a connection to the console 2 they are not accessible externally. The latching unit interacts with appropriately shaped protrusions on the console 2. Here, the fitting of the multifunction box 1 occurs essentially in two stages:

1. vertical placement of the multifunction box 1 onto the console 2 so that the latching units protrude into an appropriately formed recess in the console 2 and

2. horizontal movement of the multifunction box 1 in the direction of the rear of the vehicle for engaging the latching unit with an appropriately formed recess in the console 2 up to an end position. On reaching the end position engagement occurs whereby latching of the multifunction box occurs. The engagement is realised by a catch unit (not illustrated). This causes engagement of the multifunction box 1 in that it interacts with an appropriately formed protrusion on the console 2 on reaching the end position of the multifunction box 1 on the console 2.

The multifunction box 1 is, as can also be seen in FIG. 1, subdivided into a first rear container part 5 and a second front container part 6, although both container parts are constructionally joined together. The first container part can be closed by a lid 6 which can be opened and which in the illustrated closed state forms an arm support for the passenger travelling on the rear seats. The arm support is upholstered in a known manner and can be swivelled open towards the back. A conventional closing handle on the lid 6 is indicated at 9. In the front container part a number of functional parts are accommodated of which the controls 7 for the audio and/or video functions can be seen in the drawing in FIG. 1. The controls 7 are partly covered by a cover plate 8 which is arranged in an extension of the armrest and which can be removed essentially horizontally, the said cover plate also closing off a compartment in the front container part for small utensils.

In FIG. 2 the multifunction box 1 is illustrated with open lid 6. A spacious storage compartment can be seen which in the example is designed as an active cooler box 10. With the lid 6 closed the cooler box 10 is tightly closed by an essentially flat shelf-storage compartment 11, which is integrated into the lid and arranged beneath it and which can be swivelled open independently of or together with the lid 6 of the first container part 4. This means that the shelf-storage compartment 11 with the lid 6 open closes the cooler box 10 and to open the cooler box 10 the shelf-storage compartment is swivelled open together with the lid which keeps the shelf-storage compartment firmly closed so that no utensils can drop out. This state is illustrated in the drawing in FIG. 2.

As can also be seen in FIG. 2, the cooler box 10 is bounded on both sides by the inner walls 13 which run in the longitudinal direction of the vehicle and which are essentially parallel to the outer walls 12 of the first container part 4, between the said inner walls of which and the outer walls 12 a slot-shaped intervening space 14 being formed in each case in which a table board 15, which can be fixed to the container part 4 when in use, can be swivelled into a vertical rest position. The table board 15 can be swivelled using a (not illustrated) mechanism about two mutually perpendicular horizontal swivel axes from its vertically orientated rest position into its essentially horizontal table position, as shown in FIG. 4.

As already described, controls 7 for audio and/or video functions and/or for the control of the on-board electronics are arranged in the front container part 5, which are at least partly covered by a cover plate 8 which is arranged as an extension of the armrest formed by the lid 6. As can be seen in FIG. 3, this cover plate 8 can be lifted off in the upwards direction, whereby it is guided or held by guide strips 16 on both sides. The cover plate 8, which is moved upwards, completely exposes the controls and opens an accommodation compartment for small utensils or also a display 17 for the display of various functions. As can also be seen in FIG. 3, the cover plate 8 also forms a support console, adjustable in height, with a holder 18 for a DVD player 19 or another electronic appliance. The appliance can be moved to a position suitable for reading, viewing or operating due to the stepless height adjustment of the cover plate 8 forming the console and fixed in that position. To achieve this a latching device is provided with which the cover plate 8 can be fixed in its relevant position.

In FIG. 4 it can be seen that the cover plate 8 exhibits a punch-through opening 20, which, with the cover plate (FIGS. 1 and 2) in the closed state, enables access to the controls 7. The same parts have the same designations in all the figures. FIG. 4 also illustrates the front of the multifunction box 1 facing the direction of travel. The covers of the drinks holder 21 and the refuse compartment 22 arranged in this front container part 5 can be seen. The drinks holder 21 can be pulled out in a known manner like a drawer and exhibits receptacles for two drinks cans. The refuse compartment 22 is formed as a drawer which can be pulled out in the direction of travel.

Similarly, in the front of the multifunction box 1 two sockets 23 for the on-board power are fitted which are closed by hinged lids. Here, the plugs of external loads can be inserted, e.g. games appliance adapters, lamps, etc.

At 24 the lock is shown with which the latching mechanism of the multifunction box 1 on the console 2 can be secured against unauthorised use. The latching mechanism can only be released with a key, which may also be the vehicle key and the latching position can be seen here in a viewing window 25 which is also fitted in the front of the multifunction box 1 and the lock setting indicated by a change of colour. The latching/delatching actuator is connected to the catch unit.

Not recognisable in the drawing is an air supply duct in the bottom region of the first container part 4 which runs in the longitudinal direction of the vehicle and through which fresh and cooling air is passed from the air supply duct opening near the seat backrest to the front part of the multifunction box 1. A fan can reinforce the air flow. In FIG. 4 the recessed grip 26 can be seen in the front section of the multifunction box, with the aid of which removal and installation of the multifunction box 1 from resp. on the console 2 can be realised in an ergonomically favourable manner. At 27 a latching button is designated with which the cover plate 8 can be fixed in its relevant height position.

Finally, in FIG. 4 the table fixed to the multifunction console is illustrated, the table board of which has been previously brought out or swivelled out from the slot-shaped intervening space 14 between the outer container wall 12 and the inner container wall 13. An identical table can be extracted from the multifunction console on the opposite side once the lid 6 has in each case been previously opened.

What is claimed is:

1. Multifunction box (1) for detachable mounting on a specific support in the passenger compartment of a vehicle, in particular between the two outer rear seats (3) of a car, consisting of a first container part (4), closable by a lid (6) which can be swivelled away, the said lid (6) in the closed state forming an arm support, and a second container part (5) at the front in the direction of travel for accommodating various functional parts, characterised in that the multifunction box (1) exhibits in its bottom section a latching mechanism, with the aid of which the multifunction box (1) can be connected in a quickly releasable manner to a console (2), designed specifically for the vehicle, connected to the vehicle and which forms the support for the multifunction box (1).

2. Multifunction box (1) according to claim 1, characterised in that the latching/delatching actuator (24) for the latching mechanism holding the multifunction box (1) on the console (2) is provided in one of the side walls of the front container part.

3. Multifunction box (1) according to claim 1, characterised in that the latching/delatching actuator (24) is protected against unauthorised use.

4. Multifunction box (1) according to claim 1, characterised in that a latching status viewing window (25) is included in one of the side walls of the container part (4) or its front container part (5).

5. Multifunction box (1) according to claim 1, characterised in that a contact plug is formed in a non-visible region of the multifunction box (1), the said plug being able to be connected to an electrical connection interface integrated in the console (2) during placement of the multifunction box (1) on the console (2).

6. Multifunction box (1) according to claim 1, characterised in that an accommodation compartment (10) formed within the first container part (4) and open at the top is bounded on both sides by inner walls (13) running in the longitudinal direction of the vehicle and essentially in parallel to the outer walls (12) and between the said inner walls and the outer walls (12) a slot-shaped intervening space (14) is formed in which in each case a table board (15), which can be fixed on the container part (4 or 5), can be lowered into a rest position.

7. Multifunction box (1) according to claim 6, characterised in that the table boards (15) can be swivelled about two mutually perpendicular horizontal swivel axes from their vertically orientated rest position into their essentially horizontal table position.

8. Multifunction box (1) according to claim 6, characterised in that the accommodation compartment (10) of the first container part is formed as an active cooling compartment.

9. Multifunction box (1) according to claim 8, characterised in that the cooling compartment (10), open at the top, can be closed by the bottom of an essentially flat shelf-storage compartment (11), which can be swivelled open independently of or together with the lid (6) for the first container part (4).

10. Multifunction box (1) according to claim 1, characterised in that controls (7) for audio and or video functions and/or for the control of the on-board electronics are arranged in the front container part (5).

11. Multifunction box (1) according to claim 10, characterised in that the controls (7) are at least partly covered by an essentially horizontal cover plate (8) arranged as an extension of the armrest (lid 6).

12. Multifunction box (1) according to claim 11, characterised in that the cover plate (8) exhibits at least one punch-through opening (20) for operating the controls (7).

13. Multifunction box (1) according to claim 11, characterised in that the cover plate (8) leaves the front of an audio appliance free.

14. Multifunction box (1) according to claim 11, characterised in that the cover plate (8) can be removed from its covering position for the complete release of the controls (7) and/or other functional parts arranged in the front container part (5).

15. Multifunction box (1) according to claim 11, characterised in that the closed cover plate (8) covers an accommodation compartment for small utensils.

16. Multifunction box (1) according to claim 11, characterised in that the cover plate (8) can be moved upwards guided on guide strips (16) and can be locked in various height positions.

17. Multifunction box (1) according to claim 11, characterised in that the cover plate (8) is formed as a support console, adjustable in height, with a holder for a DVD player (19) or another electronic appliance.

18. Multifunction box (1) according to claim 1, characterised in that drinks can-holders (21) and/or shelf-storage compartments (22) are arranged in the front container part (5) to be pulled out or swivelled out.

19. Multifunction box (1) according to claim 1, characterised in that a refuse container (22) is provided in the lower section of the front container part (5).

20. Multifunction box (1) according to claim 1, characterised in that at least one on-board power socket (23) is provided in the front container part (5) and is accessible externally.

21. Multifunction box (1) according to claim 1, characterised in that in the lower section of the first container part (4) an air supply duct runs, extending in the longitudinal direction of the vehicle, through which the fresh/and cooling air is passed between the air supply duct opening near the seat backrest to the front part of the multifunction box (1).

22. Multifunction box (1) according to claim 20, characterised in that a fan is arranged in the region of the air supply duct opening.

23. Multifunction box (1) according to claim 1, characterised in that the latching mechanism exhibits at least one latching unit, formed like a hook and facing the vehicle floor, for engaging a corresponding recess in a console (2).

24. Multifunction box (1) according to claim 1, characterised in that the latching mechanism exhibits four latching units, whereby one latching unit is arranged in each corner region of the essentially rectangular bottom facing the vehicle floor.

25. Multifunction box (1) according to claim 1, characterised in that the hook-type latching mechanism exhibits a horizontal part and a vertical part, whereby the horizontal part is connected by means of the vertical part to the bottom of the multifunction box so that between the horizontal part and the bottom of the multifunction box a space similar to a groove is formed in which an appropriate protrusion of the console (2) is accepted, so that a connection, secure in a crash, between the console (2) and the multifunction box (1) can be realised.

26. Multifunction box (1) according to claim 1, characterised in that the latching mechanism exhibits a catch unit, which is connected to the latching/delatching actuator (24), whereby the catch unit prevents an unwanted release of the multifunction box (1) from the console (2).
